(19) United States
(12) Patent Application Publication
(10) Pub. No.: US 2014/0215567 A1
(43) Pub. Date: Jul. 31, 2014

(54) COMMUNICATION SYSTEM AND COMMUNICATION DEVICE

(71) Applicants: Daisuke Yoshizawa, Aichi (JP); Hirofumi Ohata, Aichi (JP); Yosuke Tomita, Aichi (JP)

(72) Inventors: Daisuke Yoshizawa, Aichi (JP); Hirofumi Ohata, Aichi (JP); Yosuke Tomita, Aichi (JP)

(73) Assignee: OMRON AUTOMOTIVE ELECTRONICS CO., LTD., Aichi (JP)

(21) Appl. No.: 14/164,380

(22) Filed: Jan. 27, 2014

(30) Foreign Application Priority Data
Jan. 28, 2013 (JP) 2013-012913

(51) Int. Cl. H04W 12/06

(52) U.S. Cl. CPC H04W 12/06
USPC 726/3

(57) ABSTRACT

A communication system has a first communication device, and a second communication device conduct wireless communication with the first communication device. The first communication device has a first transmitter that transmits a signal to the second communication device, and a first transmission controller that controls the first transmitter. The second communication device has a first receiver that receives the signal from the first communication device, a first reception controller that controls the first receiver, a signal processor that processes the signal received by the first receiver, and a determination part that determines whether the signal received by the first receiver is a normal signal. When transmitting a predetermined first signal, the first transmission controller divides the first signal into a plurality of segments to change a transmission frequency of the first transmitter in units of segments.

### BACKGROUND OF THE INVENTION

1. Technical Field

The present invention relates to a communication system and a communication device, particularly to a communication system and a communication device, in which a relay attack is difficult to perform.

2. Related Art

Nowadays, an electronic key system is becoming popular. The electronic key system includes a function (hereinafter referred to as an automatic entry function) in which a door of a vehicle can be locked and unlocked without using a mechanical key or without operating a portable key by conducting wireless communication between an in-vehicle communication device provided in the vehicle and the portable key possessed by a user.

The automatic entry function is roughly divided into the following two kinds of methods. In the first method, the door of the vehicle is automatically locked and unlocked when a user who possesses the portable key performs a predetermined operation (such that the user touches the door or such that the user operates a button provided in the door). For example, when the user performs the predetermined operation to the vehicle, an authentication request signal is transmitted from the in-vehicle communication device to a predetermined area, the portable key that receives the authentication request signal transmits a response signal including the authentication information, and the door is locked or unlocked when the authentication is successfully performed.

In the second method, the door is automatically unlocked when the user who possesses the portable key comes close to the vehicle, and the door is automatically locked when the user moves away from the vehicle. For example, the authentication request signal is periodically transmitted from the in-vehicle communication device to the predetermined area, the portable key that receives the authentication request signal transmits the response signal including the authentication information, the door is locked or unlocked when the authentication is successfully performed, and the door is locked when the response signal cannot be received.

The vehicle including the automatic entry function has a risk of a theft or an intrusion by a technique called a relay attack. As used herein, the relay attack is a technique in which, although the user who possesses the portable key is outside a communication area of the in-vehicle communication device, a malicious third party enables the communication between the in-vehicle communication device and the portable key to be conducted using a repeater, and performs such a fraud that the door of the vehicle is unlocked.

Conventionally, for the purpose of a countermeasure against the relay attack, for example, Japanese Unexamined Patent Publication No. 2008-240315 has proposed that the portable key transmits an answer telegram message a plurality of times at an assigned frequency based on an assigned frequency list transmitted from the in-vehicle communication device. In the case that RSSI values of the answer telegram messages at all the frequencies exceed a threshold, the door of the vehicle is unlocked and so on. Therefore, because it is difficult for the repeater to follow a change in frequency of the answer telegram message, the relay attack is difficult to perform.

Conventionally, for example, Japanese Unexamined Patent Publication No. 2012-67500 has proposed that a reception frequency and a transmission frequency are set by an identical logic operation based on data transmitted and received between the in-vehicle communication device and the portable key. Specifically, a reception side sets the reception frequency by performing a predetermined logic operation using data most recently transmitted to a transmission side, and the transmission side sets the transmission frequency by performing the logic operation identical to that of the reception side using the data most recently received from the reception side. The transmission side transmits the data at the set transmission frequency, and the reception side receives the data at the set reception frequency. Therefore, because it is difficult for the repeater to follow the change in frequency while the data is transmitted and received at a different frequency in each communication, the relay attack is difficult to perform.

### SUMMARY

One or more embodiments of the present invention makes it difficult to perform a relay attack.

In accordance with one or more embodiments of the present invention, in a communication system in which a first communication device and a second communication device conduct wireless communication with each other, the first communication device includes: a first transmitter that transmits a signal to the second communication device; and a first transmission controller that controls the first transmitter, the second communication device includes: a first receiver that receives the signal from the first communication device; a first reception controller that controls the first receiver; a signal processor that processes the signal received by the first receiver; and a determination part that determines whether the signal received by the first receiver is a normal signal, when transmitting a predetermined first signal, the first transmission controller divides the first signal into a plurality of segments to change a transmission frequency of the first transmitter in units of segments, when receiving the first signal, the first reception controller changes a reception frequency of the first receiver according to the transmission frequency of each segment, the signal processor combines the segments of the first signal, and the determination part determines whether the combined first signal is the normal signal.

In the communication system of one or more embodiments of the present invention, when the predetermined first signal is transmitted, the first signal is divided into the plurality of segments, and the transmission frequency is changed in units of segments. When the first signal is received, the reception frequency is changed according to the transmission frequency of each segment, the segments of the first signal are combined, and whether the combined first signal is the normal signal is determined.

Accordingly, it is difficult to perform a relay attack.

For example, one of the first communication device and the second communication device is constructed by a vehicle key fob, and the other is constructed by an in-vehicle communication device. For example, the first transmitter is constructed by various transmitting circuits or a dedicated IC. For example, the first transmission controller, the first reception controller, the signal processor, and the determination part are constructed by a microcomputer including a processor such as a CPU, or an ECU. For example, the first receiver is constructed by various receiving circuits or a dedicated IC.

The first communication device may further include: a second receiver that receives a signal from the second communication device; and a second reception controller that controls the second receiver, the second communication device may further include: a setting part that sets the transmission frequency of each segment of the first signal; a second transmitter that transmits the signal to the first communication device; and a second transmission controller that controls the second transmitter, the second transmission controller may perform control to transmit a second signal including setting information indicating a setting content performed by the setting part, the first transmission controller may set the transmission frequency of each segment of the first signal to a transmission frequency set by the setting part, and the first reception controller may change the reception frequency of the first receiver based on the transmission frequency of each segment, the transmission frequency of each segment being set by the setting part.

Therefore, it is difficult to perform a relay attack.

For example, the second receiver is constructed by various receiving circuits or a dedicated IC. For example, the second reception controller, the setting part, and the second transmission controller are constructed by a microcomputer including a processor such as a CPU, or an ECU. For example, the second transmitter is constructed by various transmitting circuits or a dedicated IC.

The setting part may further set a first-signal dividing method into the segments, the first transmission controller may divide the first signal into the plurality of segments by the dividing method set by the setting part, and set the transmission frequency of each segment to a transmission frequency set by the setting part, and the first reception controller may change the reception frequency of the first receiver based on the first-signal dividing method into the segments and the transmission frequency of each segment, the first-signal dividing method into the segments and the transmission frequency of each segment being set by the setting part.

Therefore, it is difficult to perform a relay attack.

The second communication device may be provided in a vehicle, the second communication device may further include a vehicle controller that controls processing of the vehicle, the second transmission controller may perform control so as to transmit the second signal when a predetermined operation is performed to the vehicle, or the second transmission controller may perform control so as to periodically transmit the second signal, the first transmission controller may perform control such that the first signal is transmitted in response to the second signal, and the vehicle controller may issue a command to perform a predetermined processing of the vehicle when the first signal is determined to be the normal signal.

Therefore, for example, it is difficult to perform a relay attack in the vehicle including the automatic entry function.

The first transmission controller may divide the first signal into a previously-set number of segments, and set the transmission frequency of each segment to a previously-set transmission frequency.

The determination part may determine whether the signal is the normal signal in each segment of the first signal.

Therefore, security on the first signal is further tightened, and it is difficult to perform a relay attack.

In accordance with one or more embodiments of the present invention, a communication device that conducts wireless communication with another communication device, the communication device includes: a transmitter that transmits a signal to the other communication device; and a transmission controller that controls the transmitter. In the communication device, when transmitting a predetermined signal, the transmission controller divides the predetermined signal into a plurality of segments to change a transmission frequency of the transmitter in units of segments.

In one or more embodiments of the present invention, when the predetermined signal is transmitted, the predetermined signal is divided into a plurality of segments, and the transmission frequency of the transmitter is changed in units of segments.

Accordingly, it is difficult to perform a relay attack.

For example, the transmitter is constructed by various transmitting circuits or a dedicated IC. For example, the transmission controller is constructed by a microcomputer including a processor such as a CPU, or an ECU.

In accordance with one or more embodiments of the present invention, a communication device that conducts wireless communication with another communication device, the communication device includes: a receiver that receives a signal from the other communication device; a reception controller that controls the receiver; a signal processor that processes the signal received by the receiver; and a determination part that determines whether the signal received by the receiver is a normal signal. In the communication device, when receiving a predetermined signal being divided into a plurality of segments by the other communication device to change a transmission frequency in units of segments, the reception controller changes a reception frequency of the receiver according to the transmission frequency of each segment, the signal processor combines the segments of the predetermined signal, and the determination part determines whether the combined predetermined signal is the normal signal.

In one or more embodiments of the present invention, when the predetermined signal which is divided into a plurality of segments by the other communication device to change the transmission frequency in units of segments is received, the reception frequency is changed according to the transmission frequency of each segment, the segments of the predetermined signal are combined, and whether the combined predetermined signal is the normal signal is determined.

Accordingly, it is difficult to perform a relay attack.

For example, the receiver is constructed by various receiving circuits or a dedicated IC. For example, the reception controller, the signal processor, and the determination part are constructed by a microcomputer including a processor such as a CPU, or an ECU.

According to one or more embodiments of the present invention, it is difficult to perform a relay attack.

### BRIEF DESCRIPTION OF THE DRAWINGS

FIG. 1 is a block diagram illustrating a communication system according to one or more embodiments of the present invention;

FIG. 2 is a flowchart illustrating processing of an in-vehicle system;

FIG. 3 is a flowchart illustrating the processing of the in-vehicle system;

FIG. 4 is a flowchart illustrating the processing of the in-vehicle system;

FIG. 5 is a diagram illustrating a configuration example of a response signal and a first setting example of a segment;

FIG. 6 is a diagram illustrating a configuration example of the response signal and a second setting example of the segment;

FIG. 7 is a diagram illustrating a configuration example of the response signal and a third setting example of the segment; and

FIG. 8 is a chart illustrating a signal flow between an in-vehicle communication device and a portable key.

### DETAILED DESCRIPTION

Hereinafter, embodiments of the present invention will be described. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

[Configuration Example of Communication System 101]

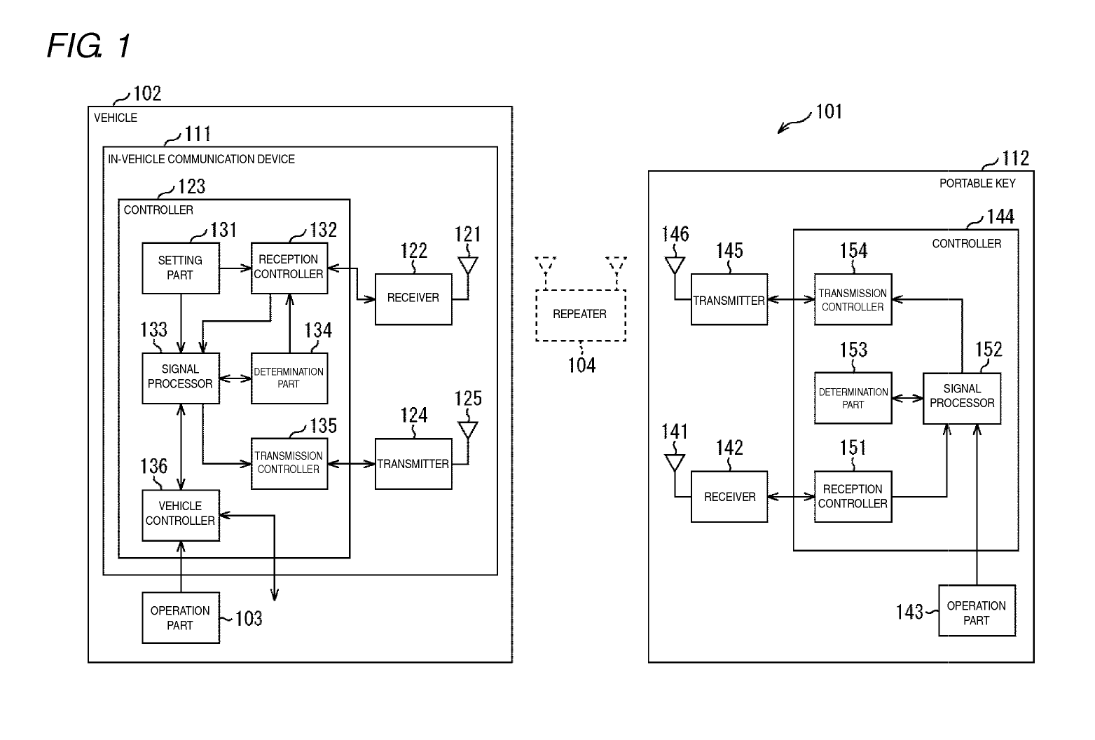

FIG. 1 is a block diagram illustrating a communication system 101 according to one or more embodiments of the present invention. The communication system 101 is used to implement a predetermined function of a vehicle 102. As used herein, for example, the predetermined function means a function of locking and unlocking a door of the vehicle 102 (automatic entry function) without using a mechanical key or operating a portable key 112, a function of starting up a driving machine such as an engine and a motor only by operating a button of the vehicle 102 (hereinafter referred to as a push start function) or a function of lighting a welcome lamp (hereinafter referred to as a welcome lamp lighting function). The welcome lamp is provided in a car or near a door mirror in order to check a situation of the vehicle 102 or a surrounding area in the dark.

As described later, in the communication system 101, a countermeasure is taken to prevent a relay attack in which a repeater 104 is used.

The communication system 101 includes an in-vehicle communication device 111 provided in the vehicle 102 and the portable key 112 possessed by a user. The in-vehicle communication device 111 and the portable key 112 conduct bidirectional wireless communication with each other.

The in-vehicle communication device 111 includes an antenna 121, a receiver 122, a controller 123, a transmitter 124, and an antenna 125.

For example, the receiver 122 is constructed by various receiving circuits or a dedicated IC. Under control of a reception controller 132 of the controller 123, the receiver 122 receives a UHF-band signal (hereinafter referred to as an RF signal) from the portable key 112 through the antenna 121, and demodulates the received RF signal. The receiver 122 can change a reception frequency under the control of the reception controller 132. The receiver 122 supplies a baseband signal obtained by demodulating the RF signal to the reception controller 132.

For example, the controller 123 is constructed by a microcomputer including a processor such as a CPU (Central Processing Unit) or an ECU (Electronic Control Unit). The controller 123 includes a setting part 131, the reception controller 132, a signal processor 133, a determination part 134, a transmission controller 135, and a vehicle controller 136.

The setting part 131 sets a method for transmitting the RF signal transmitted from the portable key 112, and supplies setting information indicating a setting content to the reception controller 132 and the signal processor 133. As used herein, the RF signal transmitting method means, for example, a division method and a transmission frequency of each segment when the RF signal is transmitted while divided into a plurality of segments.

The reception controller 132 controls the receiver 122. For example, the reception controller 132 controls the reception frequency of the receiver 122. The reception controller 132 supplies to the signal processor 133 the baseband signal supplied from the receiver 122.

The signal processor 133 performs various pieces of signal processing (for example, a signal analysis and processing based on an analysis result) to the baseband signal supplied from the reception controller 132. As needed basis, the signal processor 133 supplies a result of the signal processing and the signal, to which the signal processing is already performed, to the determination part 134, the transmission controller 135, and the vehicle controller 136. The signal processor 133 switches between performance and non-performance of the signal processing and between contents of the signal processing based on a determination result of the determination part 134. Based on the result of the signal processing or a command issued from the vehicle controller 136, the signal processor 133 generates the signal (baseband signal) to be transmitted to the portable key 112, and supplies the generated signal to the transmission controller 135.

The determination part 134 determines whether the RF signal received from the portable key 112 is the normal signal, and notifies the reception controller 132 and the signal processor 133 of the determination result.

The transmission controller 135 supplies to the transmitter 124 the baseband signal supplied from the signal processor 133. The transmission controller 135 controls the transmitter 124.

The vehicle controller 136 conducts communication with another device (for example, an ECU) provided in the vehicle 102 in order to transmit and receive various pieces of information and to issue and receive the command. The vehicle controller 136 receives the command from an operation part 103 provided in the vehicle 102.

For example, the operation part 103 includes a button, which is provided near the door of the vehicle 102 to perform the automatic entry function, and a button that is provided in the vehicle 102 to perform the push start function.

For example, the transmitter 124 is constructed by various transmitting circuits or a dedicated IC. Under the control of the transmission controller 135, the transmitter 124 modulates the baseband signal supplied from the transmission controller 135 using an LF-band carrier wave. Under the control of the transmission controller 135, the transmitter 124 transmits the modulated signal (hereinafter referred to as an LF signal) to the portable key 112 through the antenna 125.

For example, an ASK (Amplitude Shift Keying) modulation method, an FSK (Frequency Shift Keying) modulation method, and a PSK (Phase Shift Keying) modulation method can be adopted as the modulation method of the transmitter 124. The case that the ASK modulation method is adopted as the modulation method of the transmitter 124 will be described below.

For example, the portable key 112 is constructed by a key fob possessed by a user who uses the vehicle 102. The portable key 112 includes an antenna 141, a receiver 142, an operation part 143, a controller 144, a transmitter 145, and an antenna 146.

For example, receiver 142 is constructed by various receiving circuits or a dedicated IC. Under the control of a reception controller 151 of the controller 144, the receiver 142 receives the LF signal from the in-vehicle communication device 111 through the antenna 141, and demodulates the received LF signal. The receiver 122 supplies the baseband signal obtained by the demodulation of the LF signal to the reception controller 151.

For example, the operation part 143 is constructed by a button or a switch, and operated when a predetermined operation of the vehicle 102 is performed. The operation part 143 supplies the signal indicating an operation content to a signal processor 152 of the controller 144.

For example, the controller 144 is constructed by the microcomputer including the processor such as the CPU. The controller 144 includes the reception controller 151, the signal processor 152, a determination part 153, and a transmission controller 154.

The reception controller 151 controls the receiver 142. The reception controller 151 supplies to the signal processor 152 the baseband signal supplied from the receiver 142.

The signal processor 152 performs various pieces of signal processing (for example, the signal analysis and the processing based on the analysis result) to the baseband signal supplied from the reception controller 151. As needed basis, the signal processor 152 supplies the result of the signal processing and the signal, to which the signal processing is already performed, to the determination part 153 and the transmission controller 154. The signal processor 152 switches between the performance and non-performance of the signal processing and between the contents of the signal processing based on the determination result of the determination part 153. Based on the result of the signal processing or an operation signal from the operation part 143, the signal processor 152 generates the signal (baseband signal) to be transmitted to the in-vehicle communication device 111, and transmits the signal to the transmission controller 154.

The determination part 153 determines whether the LF signal received from the in-vehicle communication device 111 is the normal signal, and notifies the signal processor 152 of the determination result.

The transmission controller 154 supplies to the transmitter 145 the baseband signal supplied from the signal processor 152. The transmission controller 154 controls the transmitter 145. For example, the transmission controller 154 controls a transmission frequency of the transmitter 145.

For example, the transmitter 145 is constructed by various transmitting circuits or a dedicated IC. Under the control of the transmission controller 154, the transmitter 145 modulates the baseband signal supplied from the transmission controller 154 using a UHF-band carrier wave. The transmitter 145 can change the transmission frequency under the control of the transmission controller 154. Under the control of the transmission controller 154, the transmitter 145 transmits the modulated signal (hereinafter referred to as an RF signal) to the in-vehicle communication device 111 through the antenna 146.

For example, an ASK modulation method, a FSK modulation method, and a PSK modulation method can be adopted as the modulation method of the transmitter 145. The case that the FSK modulation method is adopted as the modulation method of the transmitter 145 will be described below.

[Processing of Communication System 101]

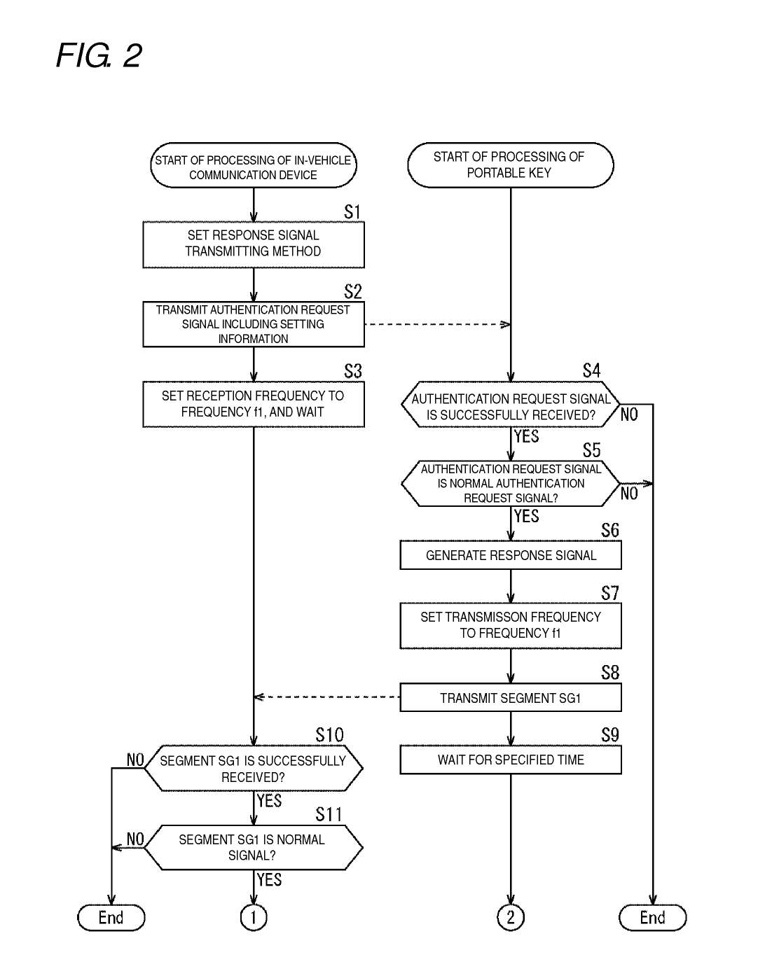

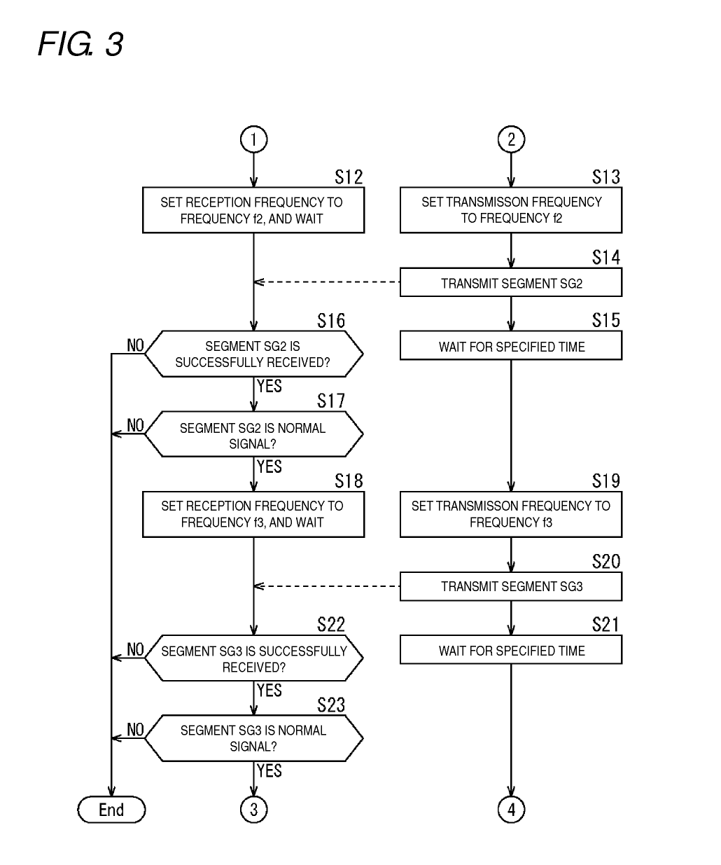

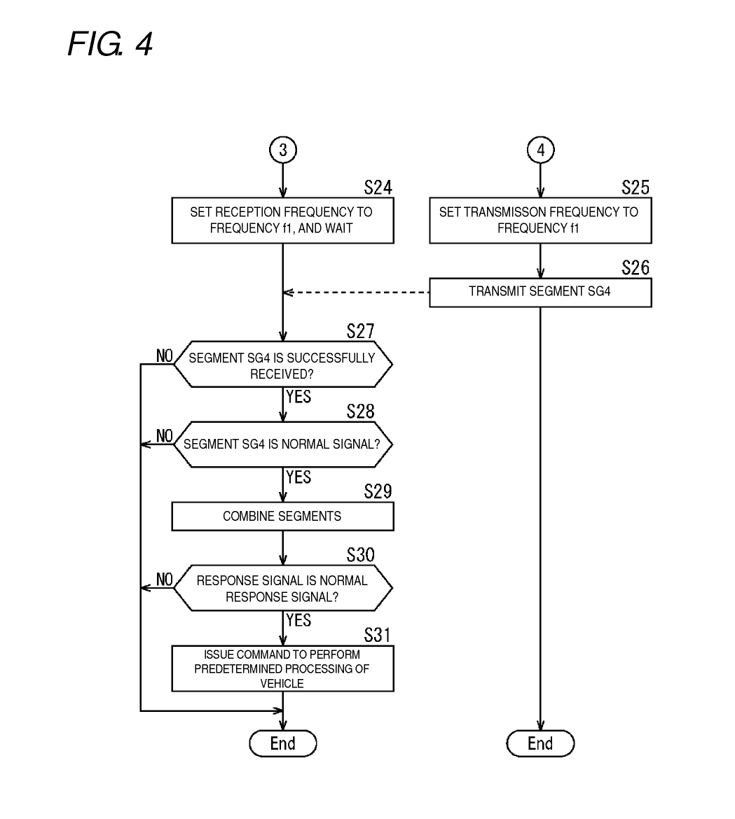

The processing of the communication system 101 will be described below with reference to FIGS. 2 to 4. Specifically, in the processing of the communication system 101, the in-vehicle communication device 111 transmits the authentication request signal, the portable key 112 that receives the authentication request signal transmits the response signal, and the in-vehicle communication device 111 that receives the normal response signal performs the pieces of processing such as the automatic entry function, the push start function, and the welcome lamp lighting function.

For example, the processing of the communication system 101 is performed when a predetermined operation (for example, the user operates the button provided in the door of the vehicle 102) is performed to the operation part 103 of the vehicle 102, or the processing is periodically performed.

In Step S1, the setting part 131 of the in-vehicle communication device 111 sets the response signal transmitting method. Specifically, as described later, when transmitting the response signal, the portable key 112 divides the response signal into a plurality of segments to change the transmission frequency in units of segments. The setting part 131 sets the response signal dividing method and the transmission frequency of each segment.

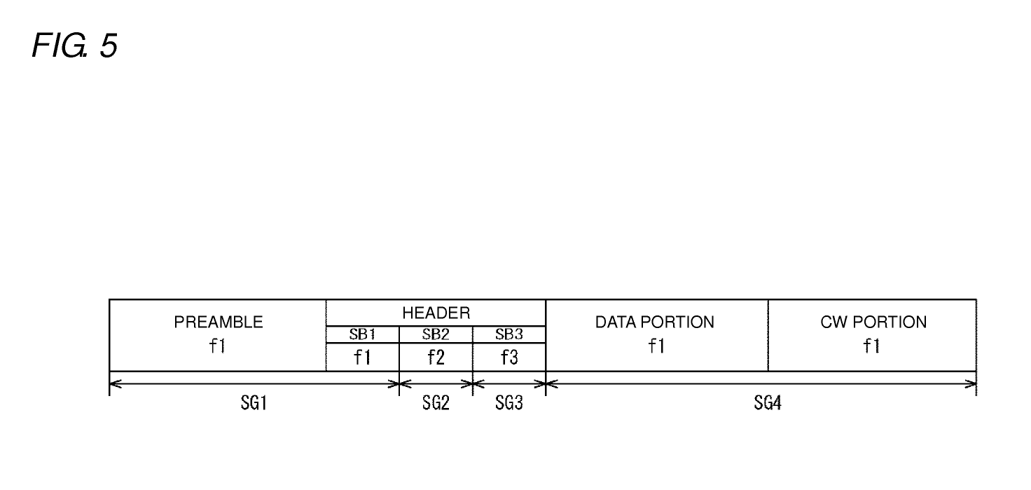

A configuration example of the response signal and a setting example of the segment will be described below with reference to FIGS. 5 to 7.

As illustrated in FIGS. 5 to 7, the response signal is divided into four blocks of a preamble, a header, a data portion, and a CW portion.

For example, the preamble is the block that includes a synchronous code having a predetermined value in order to synchronize the in-vehicle communication device 111 and the portable key 112 with each other.

The header is the block that includes data of the signal, such as the kind and the length, which is related to the authentication request signal.

The data portion is the block that includes data necessary for the processing of the in-vehicle communication device 111. For example, the data portion includes authentication information, such as ID, which identifies the portable key 112, and a command to the vehicle 102 to perform predetermined processing.

The CW portion is the block that includes a continuous wave used to measure a radio field intensity of the response signal.

FIGS. 5 to 7 illustrate examples of the case that the response signal is divided into segments SG1 to SG4. The segment is a concept different from the block of the response signal, and can be set independently of the block.

For example, in the example in FIG. 5, the header is divided into sub-blocks SB1 to SB3. The preamble and the sub-block SB1 of the header are set to the segment SG1, the sub-block SB2 of the header is set to the segment SG2, the sub-block SB3 of the header is set to the segment SG3, and the data portion and the CW portion are set to the segment SG4.

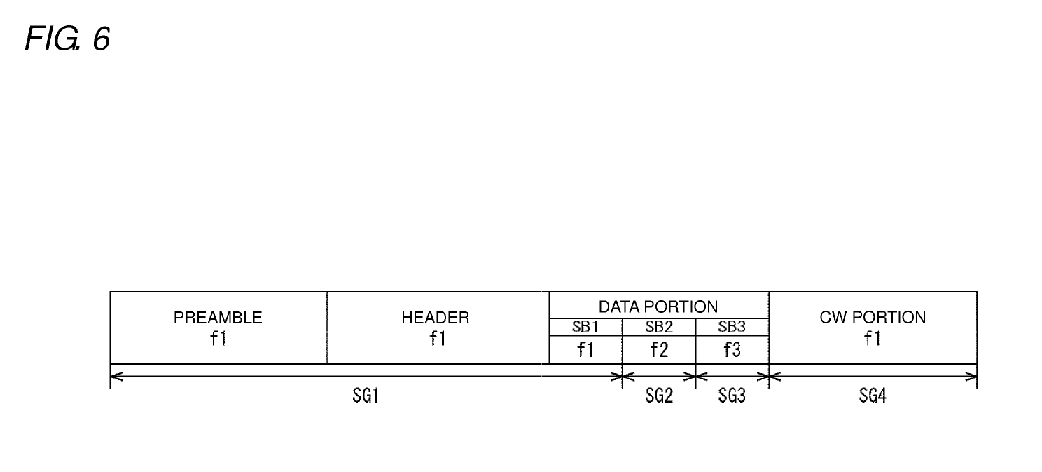

In the example in FIG. 6, the data portion is divided into the sub-blocks SB1 to SB3. The preamble, the header, and the sub-block SB1 of the data portion are set to the segment SG1, the sub-block SB2 of the data portion is set to the segment SG2, the sub-block SB3 of the data portion is set to the segment SG3, and the CW portion is set to the segment SG4.

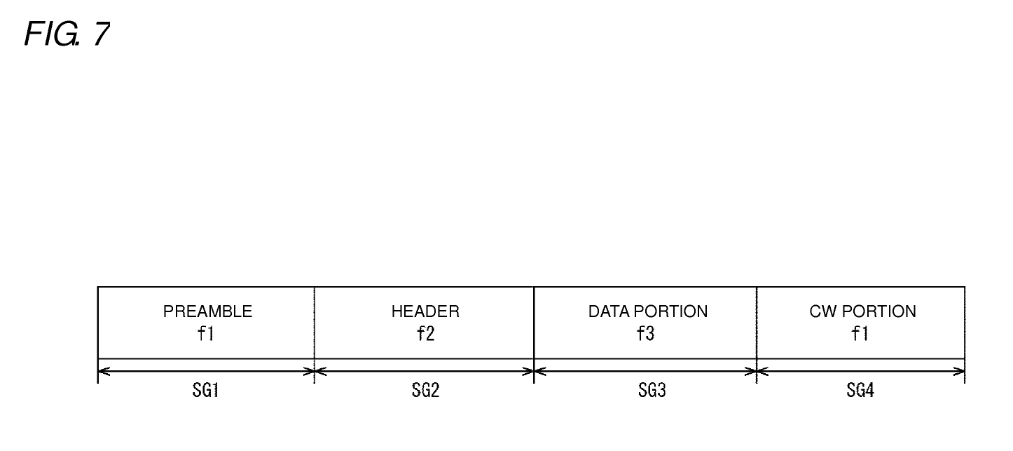

As illustrated in FIG. 7, each segment can also be set in units of blocks of the response signal. That is, the preamble may be set to the segment SG1, the header may be set to the segment SG2, the data portion may be set to the segment SG3, and the CW portion may be set to the segment SG4.

The segment number and the positions of the segments are illustrated in FIGS. 5 to 7 by way of example. The segment number and the positions of the segments may arbitrarily be changed. The segment number may be set to any number of 2 or more, the division position of the segment may be set to any position except the above positions. For example, in the example in FIG. 5, the sub-blocks SB1 to SB3 of the header can be used as the independent segments to set the total of five segments. That is, the preamble may be set to the segment SG1, the sub-block SB1 of the header may be set to the segment SG2, the sub-block SB2 of the header may be set to the segment SG3, the sub-block SB3 of the header may be set to the segment SG4, and the data portion and the CW portion may be set to the segment SG5.

The segment number and the positions of the segments may be fixed, or arbitrarily be changed. The segment number may be fixed while the position of the segment may be arbitrarily changed.

In the case that the segment number or the position of the segment is variable, the setting part 131 sets the response signal dividing method. As used herein, the response signal dividing method means the method for determining the position of each segment in the response signal.

For example, in the response signal dividing method, the position of each segment may specifically be set in the response signal, or a parameter or an algorithm may be set to calculate the position of each segment. In the latter case, it is conceivable that only a segment number n is set, and that the response signal is equally divided into n pieces to set the position of each segment. It is also conceivable that a division number m of a predetermined block (for example, data portion) of the response signal is set, and that the block is divided into m pieces to set the position of each segment.

Whether the segment number and the position of the segment are fixed or variable, the setting part 131 sets the transmission frequency of each segment. The transmission frequency of each segment can be set to any value within a frequency range that can be transmitted by the transmitter 145 of the portable key 112 and received by the receiver 122 of the in-vehicle communication device 111. However, desirably the transmission frequencies of the segments adjacent to each other are set to values that are different from each other by at least a predetermined threshold.

In the examples in FIGS. 5 to 7, the transmission frequency of the segment SG1 is set to a frequency f1, the transmission frequency of the segment SG2 is set to a frequency f2, the transmission frequency of the segment SG3 is set to a frequency f3, and the transmission frequency of the segment SG4 is set to a frequency f1.

For example, the position of each segment may be set based on the transmission frequency. For example, it is conceivable that the response signal is divided into the n segments by setting the n transmission frequencies and the order, and that a width of each segment is set based on a ratio of the transmission frequency.

The setting part 131 supplies the setting information indicating the setting content of the response signal transmitting method to the reception controller 132 and the signal processor 133.

The case that the position and transmission frequency of each segment are set as illustrated in FIG. 5 will be described below.

In Step S2, the in-vehicle communication device 111 transmits the authentication request signal including the setting information. Specifically, the signal processor 133 generates the authentication request signal, and supplies the authentication request signal to the transmitter 124 through the transmission controller 135. The authentication request signal includes the authentication information, such as the ID, which identifies the in-vehicle communication device 111, and the setting information set by the setting part 131 in the processing of Step S1. Under the control of the transmission controller 135, the transmitter 124 ASK-modulates the authentication request signal, and transmits the modulated authentication request signal through the antenna 125.

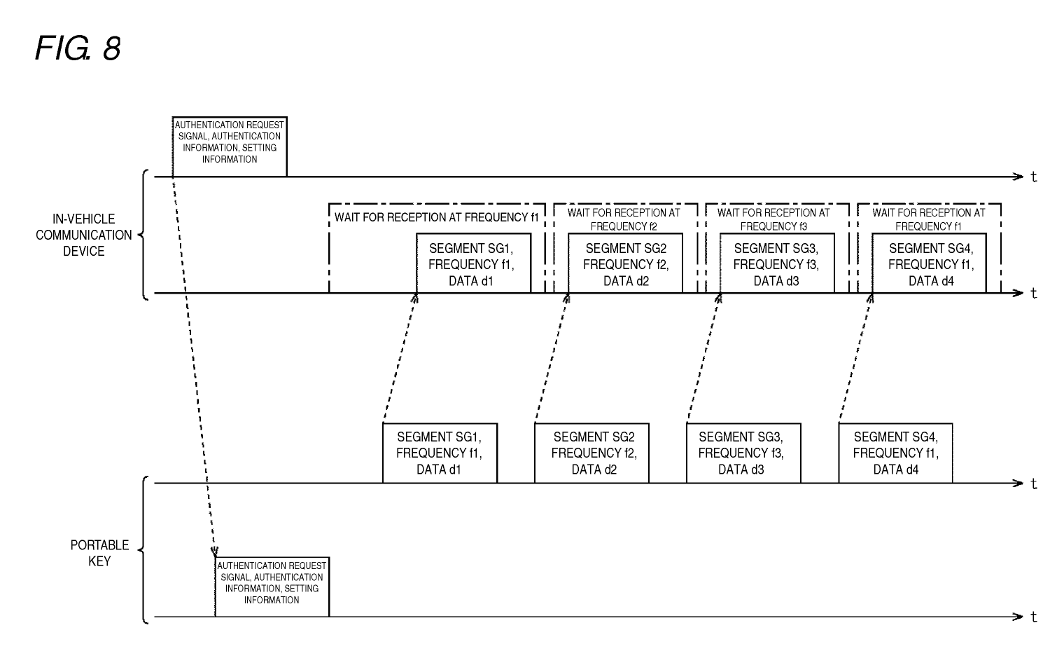

Therefore, as illustrated in FIG. 8, the authentication request signal including the authentication information and the setting information is transmitted from the in-vehicle communication device 111 to the portable key 112.

In Step S3, the in-vehicle communication device 111 waits while the reception frequency is set to the frequency f1. That is, the reception controller 132 of the in-vehicle communication device 111 sets the reception frequency of the receiver 122 to the frequency f1. As illustrated in FIG. 8, the in-vehicle communication device 111 waits for the reception at the frequency f1 in association with the transmission frequency of the segment S1 of the response signal transmitted from the portable key 112.

Then the processing of the in-vehicle communication device 111 goes to Step S10.

On the other hand, in Step S4, the portable key 112 determines whether the authentication request signal is successfully received. Specifically, when receiving the authentication request signal transmitted from the in-vehicle communication device 111 in the processing of Step S2 through the antenna 141, the receiver 142 of the portable key 112 demodulates the received authentication request signal. The receiver 142 supplies the demodulated authentication request signal to the signal processor 152 through the reception controller 151. The reception controller 151 determines that the authentication request signal is successfully received when the processing in Step S4 can be performed without fail within predetermined time. Then the processing goes to Step S5.

In Step S5, the determination part 153 of the portable key 112 determines whether the authentication request signal is the normal authentication request signal. Specifically, the signal processor 152 supplies the authentication request signal to the determination part 153. In the case that the data included in the authentication request signal is encrypted, the signal processor 152 decodes the encrypted data, and supplies the decoded data to the determination part 153.

The determination part 153 of the portable key 112 determines whether the authentication request signal is the normal authentication request signal based on a predetermined determination condition. For example, the determination part 153 determines whether the authentication request signal is the normal authentication request signal based on whether a format of the authentication request signal is correct, whether the data included in the authentication request signal is successfully decoded, the determination result of an error detection code such as CRC (Cyclic Redundancy Check), and the authentication result of the authentication information included in the authentication request signal. When the authentication request signal is determined to be the normal authentication request signal, the processing goes to Step S6.

In Step S6, the signal processor 152 generates the response signal. Specifically, the signal processor 152 generates the response signal based on the format in FIGS. 5 to 7. The signal processor 152 divides the generated response signal into the segments SG1 to SG4 based on the setting information included in the authentication request signal. The signal processor 152 supplies the segments SG1 to SG4 of the generated response signal to the transmitter 145 through the transmission controller 154. The signal processor 152 supplies the setting information included in the authentication request signal to the transmission controller 154.

In Step S7, the transmission controller 154 of the portable key 112 sets the transmission frequency of the transmitter 145 to the frequency f1.

In Step S8, the portable key 112 transmits the segment SG1 of the response signal. Specifically, under the control of the transmission controller 154, the transmitter 145 of the portable key 112 PSK-modulates the segment SG1 of the response signal, and transmits the modulated segment SG1 through the antenna 146.

Therefore, as illustrated in FIG. 8, the portable key 112 transmits the segment SG1 of the response signal including data d1 at the frequency f1 to the in-vehicle communication device 111 that waits for the reception at the frequency f1.

In Step S9, the portable key 112 waits for specified time.

Then the processing of the portable key 112 goes to Step S13.

When the portable key 112 is determined to fail to receive the authentication request signal in Step S4, or when the authentication request signal is determined to be not the normal authentication request signal in Step S5, the response signal is not transmitted, and the processing of the portable key 112 is ended.

On the other hand, in Step S10, the in-vehicle communication device 111 determines whether the segment SG1 of the response signal is successfully received. Specifically, when receiving the segment SG1 of the response signal transmitted from the portable key 112 in the processing of Step S8 through the antenna 121, the receiver 122 of the in-vehicle communication device 111 demodulates the response signal. The receiver 142 supplies the demodulated response signal to the signal processor 133 through the reception controller 132. The reception controller 132 determines that the segment SG1 of the response signal is successfully received when the processing in Step S10 can be performed without fail within predetermined time. Then the processing goes to Step S11.

In Step S11, the determination part 134 of the in-vehicle communication device 111 determines whether the segment SG1 is the normal signal. Specifically, the signal processor 133 supplies the segment SG1 to the determination part 134. In the case that the data included in the segment SG1 is encrypted, the signal processor 133 decodes the encrypted data, and supplies the decoded data to the determination part 134.

The determination part 134 determines whether the segment SG1 is the normal signal based on a predetermined determination condition. For example, the determination part 134 determines whether the segment SG1 is the normal signal based on whether the format of the segment SG1 is correct, whether the data included in the segment SG1 is successfully decoded, and the determination result of the error detection code such as the CRC. When the segment SG1 is determined to be the normal signal, the processing goes to Step S12.

In Step S12, the in-vehicle communication device 111 waits while the reception frequency is set to the frequency f2. Specifically, the determination part 134 notifies the reception controller 132 and the signal processor 133 that the segment SG1 of the response signal is the normal signal. The reception controller 132 changes the reception frequency of the receiver 122 to the frequency f2. As illustrated in FIG. 8, the in-vehicle communication device 111 waits for the reception at the frequency f2 in association with the transmission frequency of the segment S2 of the response signal transmitted from the portable key 112.

Then the processing of the in-vehicle communication device 111 goes to Step S16.

When the in-vehicle communication device 111 is determined to fail to receive the segment SG1 of the response signal in Step S10, or when the segment SG1 of the response signal is determined to be not the normal signal in Step S11, the processing of the in-vehicle communication device 111 is ended.

On the other hand, in Step S13, the transmission controller 154 of the portable key 112 sets the transmission frequency of the transmitter 145 to the frequency f2.

In Step S14, similarly to the processing in Step S8, the portable key 112 transmits the segment SG2 of the response signal.

Therefore, as illustrated in FIG. 8, the portable key 112 transmits the segment SG2 of the response signal including data d2 at the frequency f2 to the in-vehicle communication device 111 that waits for the reception at the frequency f2.

In Step S15, the portable key 112 waits for specified time.

Then the processing of the portable key 112 goes to Step S19.

In Step S16, similarly to the processing in Step S10, the in-vehicle communication device 111 determines whether the segment SG2 of the response signal is successfully received. When the segment SG2 of the response signal is determined to be successfully received, the processing goes to Step S17.

In Step S17, similarly to the processing in Step S11, the in-vehicle communication device 111 determines whether the segment SG2 of the response signal is the normal signal. When the segment SG2 of the response signal is determined to be the normal signal, the processing goes to Step S18.

In Step S18, similarly to the processing in Step S12, the in-vehicle communication device 111 waits while the reception frequency is set to the frequency f3.

Then the processing of the in-vehicle communication device 111 goes to Step S22.

When the in-vehicle communication device 111 is determined to fail to receive the segment SG2 of the response signal in Step S16, or when the segment SG2 of the response signal is determined to be not the normal signal in Step S17, the processing of the in-vehicle communication device 111 is ended.

On the other hand, in Step S19, the transmission controller 154 of the portable key 112 sets the transmission frequency of the transmitter 145 to the frequency f3.

In Step S20, similarly to the processing in Step S8, the portable key 112 transmits the segment SG3 of the response signal.

Therefore, as illustrated in FIG. 8, the portable key 112 transmits the segment SG3 of the response signal including data d3 at the frequency f3 to the in-vehicle communication device 111 that waits for the reception at the frequency f3.

In Step S21, the portable key 112 waits for specified time.

Then the processing of the portable key 112 goes to Step S25.

In Step S22, similarly to the processing in Step S10, the in-vehicle communication device 111 determines whether the segment SG3 of the response signal is successfully received. When the segment SG3 of the response signal is determined to be successfully received, the processing goes to Step S23.

In Step S23, similarly to the processing in Step S11, the in-vehicle communication device 111 determines whether the segment SG3 of the response signal is the normal signal. When the segment SG3 of the response signal is determined to be the normal signal, the processing goes to Step S24.

In Step S24, similarly to the processing in Step S12, the in-vehicle communication device 111 waits while the reception frequency is set to the frequency f1.

Then the processing of the in-vehicle communication device 111 goes to Step S27.

In Step S25, the transmission controller 154 of the portable key 112 sets the transmission frequency of the transmitter 145 to the frequency f1.

In Step S26, similarly to the processing in Step S8, the portable key 112 transmits the segment SG4 of the response signal.

Therefore, as illustrated in FIG. 8, the portable key 112 transmits the segment SG4 of the response signal including data d4 at the frequency f1 to the in-vehicle communication device 111 that waits for the reception at the frequency f1.

Then the processing of the portable key 112 is ended.

In Step S27, similarly to the processing in Step S10, the in-vehicle communication device 111 determines whether the segment SG4 of the response signal is successfully received. When the segment SG4 of the response signal is determined to be successfully received, the processing goes to Step S28.

In Step S28, similarly to the processing in Step S11, the in-vehicle communication device 111 determines whether the segment SG4 of the response signal is the normal signal. When the segment SG4 of the response signal is determined to be the normal signal, the processing goes to Step S29.

In Step S29, the in-vehicle communication device 111 combines the segments. Specifically, the determination part 134 notifies the reception controller 132 and the signal processor 133 that the segment SG4 of the response signal is the normal signal. The signal processor 133 restores the response signal by combining the segments SG1 to SG4.

In Step S30, the determination part 134 of the in-vehicle communication device 111 determines whether the response signal is the normal response signal. Specifically, the signal processor 133 supplies the response signal restored by the combination to the determination part 134. The determination part 134 determines whether the response signal is the normal response signal based on a predetermined determination condition. For example, the determination part 134 determines whether the response signal is the normal response signal based on the authentication result of the authentication information on the portable key 112, which is included in the response signal, and whether the command included in the response signal is the normal command. When the response signal is determined to be the normal response signal, the processing goes to Step S31.

In Step S31, the vehicle controller 136 issues the command to perform the predetermined processing of the vehicle 102. Specifically, the determination part 134 notifies the signal processor 133 that the response signal is the normal signal. The signal processor 133 supplies the command included in the response signal to the vehicle controller 136. The vehicle controller 136 issues the command to another device such as the ECU in the vehicle 102 to perform the processing corresponding to the acquired command. Therefore, the processing such as the automatic entry function, the push start function, and the welcome lamp lighting function is performed.

Then the in-vehicle communication device 111 ends the processing.

On the other hand, when the response signal is determined to be not the normal response signal in Step S30, the processing in Step S31 is skipped, and the processing of the in-vehicle communication device 111 is ended without issuing the command to perform the predetermined processing of the vehicle 102.

When the in-vehicle communication device 111 is determined to fail to receive the segment SG4 in Step S27, or when the segment SG4 is determined to be not the normal signal in Step S28, the processing of the in-vehicle communication device 111 is ended.

As described above, it is difficult to perform a relay attack, because it is difficult for the repeater 104 to follow the change in transmission frequency while the transmission frequency of the response signal changes in units of segments.

Because the segment number, the segment position, and the transmission frequency are changed in each communication, it is difficult for the repeater 104 to respond to the changes, and it is difficult to perform a relay attack.

Because the normality is determined in each segment of the response signal, security on the response signal is further tightened, and it is difficult to perform a relay attack.

Modifications of one or more embodiments of the present invention will be described below.

[First Modification: Modifications Related to Segment and Transmission Frequency]

For example, the number, position, and transmission frequency of the segment of the response signal may not be variable, but may be fixed to predetermined values. In this case, although the security of the communication is slightly degraded compared with the case that the number, position, and transmission frequency of the segment are variable, it is difficult to perform a relay similarly to the case that the number, position, and transmission frequency of the segment are variable, because it is difficult for the repeater 104 to follow the change in transmission frequency of the response signal.

In one or more of the above embodiments, by way of example, the transmission frequency of the response signal is changed under the initiative of the in-vehicle communication device 111 on the reception side. Alternatively, the transmission frequency of the response signal may be changed under the initiative of the portable key 112 on the transmission side. That is, the portable key 112 may set the response signal dividing method and the transmission frequency, and transmit the response signal according to the set contents. In this case, for example, it is conceivable that the transmission frequency is fixed in the head portion of the response signal, and that the portable key 112 notifies the in-vehicle communication device 111 of the number, position, and transmission frequency of the segment in the head portion. Therefore, the transmission frequency of the portable key 112 and the reception frequency of the in-vehicle communication device 111 can be matched with each other at the beginning of the transmission of the response signal, and the frequency can freely be changed during the transmission of the response signal.

In the case that the authentication request signal is transmitted, similar to the case that the response signal is transmitted, the authentication request signal can be divided into a plurality of segments, and the transmission frequency can be changed in units of segments. In the case that the number, position, and transmission frequency of the segment of the authentication request signal are variable in each communication, for example, it is conceivable that the transmission frequency is fixed in the head portion of the response signal, and that the in-vehicle communication device 111 notifies the portable key 112 of the number, position, and transmission frequency of the segment in the head portion.

The transmission frequencies of both the response signal and the authentication request signal may be changed in units of segments, or the transmission frequency of one of the response signal and the authentication request signal may be changed in units of segments.

[Second Modification: Modification Related to Device Configuration]

The configuration of the in-vehicle communication device 111 is not limited to the example in FIG. 1, but the configuration of the in-vehicle communication device 111 can be changed in various ways. For example, the reception controller 132 and the transmission controller 135 may be provided outside the controller 123, or the receiver 122 and the transmitter 124 may be provided in the controller 123. For example, the receiver 122 and the reception controller 132 may be combined, or the transmitter 124 and the transmission controller 135 may be combined. For example, the receiver 122 and the transmitter 124 may be combined. In the in-vehicle communication device 111, the portion in which the transmission processing is performed and the portion in which the reception processing is performed may be divided into two devices.

The configuration of the portable key 112 is not limited to the example in FIG. 1, but the configuration of the portable key 112 can be changed in various ways. For example, the reception controller 151 and the transmission controller 154 may be provided outside the controller 144, or the receiver 142 and the transmitter 145 may be provided in the controller 144. For example, the receiver 142 and the reception controller 151 may be combined, or the transmitter 145 and the transmission controller 154 may be combined. For example, the receiver 142 and the transmitter 145 may be combined.

The number of portable keys 112 is not limited to one, but at least two portable keys 112 may be provided. The number of in-vehicle communication devices 111 is not limited to one, but at least two in-vehicle communication devices 111 may be provided.

[Third Modification: Other Modifications]

In one or more of the above embodiments, the normality is determined in not only the combined response signal but also each segment. Alternatively, the normality determination processing may be eliminated in each segment to determine only the normality of the combined response signal.

For example, the waiting time after the portable key 112 transmits the segment of the response signal may be set from the in-vehicle communication device 111.

There is no particular limitation to the kind of the vehicle to which one or more embodiments of the present invention is applied. For example, one or more embodiments of the present invention can be applied to not only four-wheel vehicles such as an automobile but also other kinds of vehicles such as a two-wheel vehicle.

One or more embodiments of the present invention can also be applied to the wireless communication system except the vehicle. For example, one or more embodiments of the present invention can effectively be applied to a system in which one of the communication devices automatically transmits the response signal in response to the request from the other communication device. For example, one or more embodiments of the present invention is effectively applied to the system in which the authentication request signal is transmitted to the portable key from the communication device provided in a building when a door of the building is operated, and the door is locked or unlocked in response to the response signal from the portable key.

[Configuration Example of Computer]

The series of pieces of processing can be performed by hardware or software. In the case that the series of pieces of processing are performed by the software, a program constituting the software is installed in the computer. Examples of the computer include a computer incorporated in the dedicated hardware and a general-purpose personal computer in which various programs are installed to be able to perform various functions.

For example, the program executed by the computer can be provided while recorded in a removable medium as a package medium. The program can also be provided through a wireless or wired transmission medium such as a local area network, the Internet, and a digital satellite broadcasting.

For example, the program can previously be installed in the ROM or storage part.

The program may be executed by the computer in time series along the procedure of one or more of the embodiments, concurrently executed by the computer, or executed by the computer in necessary timing such as calling.

As used herein, the system means a set of a plurality of structural elements (such as the device and a module (component)) whether all the structural elements exist in a chassis or not. Accordingly, both a plurality of devices accommodated in individual chassis while connected to each other through a network and one device in which a plurality of modules are accommodated in one chassis are the system.

The present invention is not limited to the above embodiments, but various changes can be made without departing from the scope of the present invention.

Each step described in the flowcharts can be performed by one device, or the step can be performed while shared by a plurality of devices.

In the case that a plurality of pieces of processing are included in one step, the plurality of pieces of processing included in the one step can be performed by one device, or the plurality of pieces of processing included in the one step can be performed by the plurality of devices while shared by the plurality of devices.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A communication system comprising:
a first communication device; and
a second communication device conduct wireless communication with the first communication device,
wherein the first communication device comprises:
a first transmitter that transmits a signal to the second communication device, and
a first transmission controller that controls the first transmitter,
wherein the second communication device comprises:
a first receiver that receives the signal from the first communication device,
a first reception controller that controls the first receiver,
a signal processor that processes the signal received by the first receiver, and
a determination part that determines whether the signal received by the first receiver is a normal signal,
wherein, when transmitting a predetermined first signal, the first transmission controller divides the first signal into a plurality of segments to change a transmission frequency of the first transmitter in units of segments,
wherein, when receiving the first signal, the first reception controller changes a reception frequency of the first receiver according to the transmission frequency of each segment,
wherein the signal processor combines the segments of the first signal, and
wherein the determination part determines whether the combined first signal is the normal signal.

2. The communication system according to claim 1,
wherein the first communication device further comprises:
a second receiver that receives a signal from the second communication device; and
a second reception controller that controls the second receiver,
wherein the second communication device further comprises:
a setting part that sets the transmission frequency of each segment of the first signal,
a second transmitter that transmits the signal to the first communication device, and
a second transmission controller that controls the second transmitter,
wherein the second transmission controller performs control to transmit a second signal including setting information indicating a setting content performed by the setting part,
wherein the first transmission controller sets the transmission frequency of each segment of the first signal to a transmission frequency set by the setting part, and
wherein the first reception controller changes the reception frequency of the first receiver based on the transmission frequency of each segment, the transmission frequency of each segment being set by the setting part.

3. The communication system according to claim 2,
wherein the setting part further sets a first-signal dividing method into the segments,
wherein the first transmission controller divides the first signal into the plurality of segments by the dividing method set by the setting part, and sets the transmission frequency of each segment to a transmission frequency set by the setting part, and
wherein the first reception controller changes the reception frequency of the first receiver based on the first-signal dividing method into the segments and the transmission frequency of each segment, the first-signal dividing method into the segments and the transmission frequency of each segment being set by the setting part.

4. The communication system according to claim 2,
wherein the second communication device is provided in a vehicle,
wherein the second communication device further includes a vehicle controller that controls processing of the vehicle,
wherein the second transmission controller performs control so as to transmit the second signal when a predetermined operation is performed to the vehicle, or the second transmission controller performs control so as to periodically transmit the second signal,
wherein the first transmission controller performs control such that the first signal is transmitted in response to the second signal, and
wherein the vehicle controller issues a command to perform a predetermined processing of the vehicle when the first signal is determined to be the normal signal.

5. The communication system according to claim 1, wherein the first transmission controller divides the first signal into a previously-set number of segments, and sets the transmission frequency of each segment to a previously-set transmission frequency.

6. The communication system according to claim 1, wherein the determination part determines whether the signal is the normal signal in each segment of the first signal.

7. A communication device that conducts wireless communication with another communication device, comprising:
a transmitter that transmits a signal to the another communication device; and
a transmission controller that controls the transmitter,
wherein, when transmitting a predetermined signal, the transmission controller divides the predetermined signal into a plurality of segments to change a transmission frequency of the transmitter in units of segments.

8. A communication device that conducts wireless communication with another communication device, comprising:
a receiver that receives a signal from the another communication device;
a reception controller that controls the receiver;
a signal processor that processes the signal received by the receiver; and
a determination part that determines whether the signal received by the receiver is a normal signal,
wherein, when receiving a predetermined signal being divided into a plurality of segments by the another communication device to change a transmission frequency in units of segments, the reception controller changes a reception frequency of the receiver according to the transmission frequency of each segment,
wherein the signal processor combines the segments of the predetermined signal, and
wherein the determination part determines whether the combined predetermined signal is the normal signal.

9. The communication system according to claim 3,
wherein the second communication device is provided in a vehicle,
wherein the second communication device further includes a vehicle controller that controls processing of the vehicle,
wherein the second transmission controller performs control so as to transmit the second signal when a predetermined operation is performed to the vehicle, or the second transmission controller performs control so as to periodically transmit the second signal,
wherein the first transmission controller performs control such that the first signal is transmitted in response to the second signal, and
wherein the vehicle controller issues a command to perform a predetermined processing of the vehicle when the first signal is determined to be the normal signal.

10. The communication system according to claim 2, wherein the determination part determines whether the signal is the normal signal in each segment of the first signal.

11. The communication system according to claim 3, wherein the determination part determines whether the signal is the normal signal in each segment of the first signal.

12. The communication system according to claim 4, wherein the determination part determines whether the signal is the normal signal in each segment of the first signal.

13. The communication system according to claim 5, wherein the determination part determines whether the signal is the normal signal in each segment of the first signal.
